(19) United States
(12) Patent Application Publication
(10) Pub. No.: US 2015/0066738 A1
(43) Pub. Date: Mar. 5, 2015

(54) SYSTEM AMD METHOD FOR DETECTING SHORT SALE FRAUD

(71) Applicant: Corelogic Solutions, LLC, Irvine, CA (US)

(72) Inventors: Liang TIAN, Irvine, CA (US); David Lisuk, Irvine, CA (US); Xiaolin Tan, Irvine, CA (US); Brian Pozza, Irvine, CA (US); Greg Pint, Irvine, CA (US); Jacqueline Doty, Irvine, CA (US); Susan Allen, Irvine, CA (US); Matthias Blume, Irvine, CA (US)

(73) Assignee: Corelogic Solutions, LLC, Irvine, CA (US)

(21) Appl. No.: 14/056,614

(22) Filed: Oct. 17, 2013

Related U.S. Application Data
(60) Provisional application No. 61/872,337, filed on Aug. 30, 2013.

(51) Int. Cl. G06Q 40/02; G06Q 50/16

(52) U.S. Cl. CPC G06Q 40/025; G06Q 50/16
USPC 705/38

(57) ABSTRACT

Computer-based systems and methods are disclosed for modeling and predicting short sale fraud risks for short sale transactions related to real estate properties. In some embodiments, the systems and methods can predict short sale fraud risks for real estate properties by considering a variety of factors, including AVM analytics characteristics, relationship analysis characteristics, and/or marketing analysis characteristics.

### CROSS-REFERENCE TO RELATED APPLICATIONS

The present application contains subject matter related to that disclosed in U.S. Pat. No. 8,498,929, the entire contents of which is hereby incorporated herein by reference in its entirety. The present application also claims the benefit of the earlier filing date of commonly owned U.S. Provisional Patent Application 61/872,337, entitled “SYSTEM AND METHOD FOR DETECTING SHORT SALE FRAUD,” filed on Aug. 30, 2013, the entire contents of which are hereby incorporated by reference in its entirety.

### BACKGROUND

1. Field

The present disclosure relates to systems, methods and computer program products that monitor real property transaction data, and detects signs of potential improper activity. In particular, the system, method and computer program product monitor real property transaction data to detect potential short sale fraud.

2. Description of the Related Art

A homeowner who is unable to pay their mortgage and is “underwater,” i.e. the home is worth less than the amount the homeowner mortgage, may seek a lender's permission for a “short sale”. A short sale of real estate occurs when the sale proceeds fall short of the balance owed on the property's loan. Often the lender decides that selling the property at a moderate loss is better than pressing the borrower who is already underwater and may not be able to afford the mortgage. Both parties consent to the short sale process because it allows them to avoid foreclosure, which involves hefty fees for the bank and poorer credit report outcomes for the borrowers. This agreement, however, does not necessarily release the borrower from the obligation to pay the remaining balance of the loan, known as the deficiency.

As the number of “short sales” has increased, so has the number of fraudulent activities related to “short sales.” A common technique usually involves real estate insiders (i.e. real estate agents/brokers) who broker a short sale between the servicer and a buyer who serves as a middleman at a below-market value. The insider subsequently brokers a quick resale of the property from the middleman to an arms-length buyer at market value. It is common to observe re-sales occur as soon as one day after the short sale closes with the original servicer. Because the real estate broker does not disclose to the servicer the higher value offer that should be available to them from the arms-length buyer, they are defrauded out of receiving the best price possible.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to detect short sale fraud.

FIG. 2 is a schematic diagram illustrating an aspect of the short sale fraud risk model that provides an overall short sale fraud risk assessment for real estate properties.

FIG. 3 is a block diagram that schematically illustrates an example of one or more factors that may be considered in a system to perform relationship analysis for real estate properties.

FIG. 4 is a block diagram that schematically illustrates an example of one or more factors that may be considered in a system to perform marketing analysis for real estate properties.

FIG. 5 is a flowchart that illustrates an example of a method for performing AVM analytics in accordance with an embodiment.

FIG. 6 is a flowchart that illustrates an example of a method for performing relationship analysis in accordance with an embodiment.

FIG. 7 is a flowchart that illustrates an example of a method for performing marketing analysis in accordance with an embodiment.

FIG. 8 is a flowchart illustrating a method of calculating a short sale fraud risk score in accordance with an embodiment.

FIG. 9 is a flowchart illustrating a method of building a short sale fraud risk model in accordance with an embodiment.

FIG. 10 is a flowchart illustrating an example of a post-closing short sale fraud method in accordance with an embodiment.

### DETAILED DESCRIPTION

Various aspects of the disclosure will now be described with regard to certain examples and embodiments, which are intended to illustrate but not to limit the disclosure.

Computer-based systems and methods are disclosed for modeling and predicting short sale fraud risks for real estate properties. In some embodiments, the systems and methods can predict short sale fraud risks for real estate properties by considering a variety of factors, including AVM analytics characteristics, marketing analysis characteristics, and/or relationship analysis characteristics.

In various embodiments, a short sale fraud risk score may be determined for a short sale transaction related to a property that provides a comprehensive assessment of the property's risk of short sale fraud. Further, determining the short sale fraud risk score may include determining one or more short sale fraud risk characteristics for the short sale transaction related to the property, and assigning a short sale fraud risk score that corresponds to the one or more short sale fraud risk characteristics. In some embodiments, short sale risk characteristics may include AVM analytics, marketing analysis characteristics including number of photographs, quality/type of advertising remarks, duration of any advertising, or any inconsistencies with public records, and/or relationship analysis characteristics. For example, a first short sale fraud risk characteristic and a second short sale fraud risk characteristic may be used to assign a first score component and a second score component, respectively, that may be summed together to form a short sale fraud risk score. Other numbers of components (e.g., for considering additional short sale fraud risk characteristics) are also contemplated. Other ways of combining the score components are also contemplated (e.g., the score components may be averaged or weighted together).

### Example Real Estate OA Analytics System

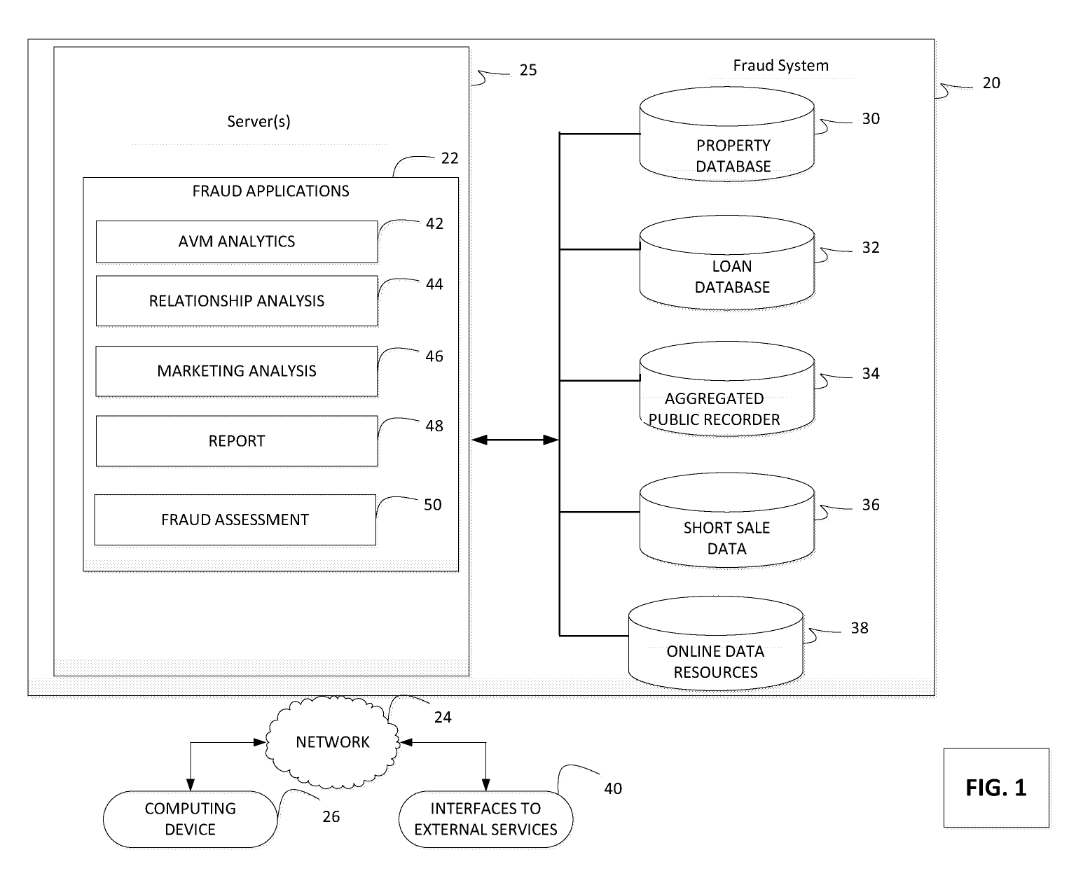

FIG. 1 illustrates a fraud system 20 according to one embodiment. The system may be provided by a business entity or “fraud provider” that provides various services to its customers for assessing fraud and financial risks associated with real estate properties. As illustrated, the system includes a set of fraud applications 22 that are accessible over a network 24 (such as the Internet) via a computing device 26 (desktop computers, mobile phones, servers, etc.). Typical customers of the system 20 include mortgage lenders, other types of lenders, mortgage and default servicers, real estate investors, real estate brokers, and real estate appraisers.

As illustrated, fraud applications 22 use a set of data repositories 30-38 to perform various types of analytics tasks, including tasks associated with detecting short sale fraud. In the illustrated embodiment, these data repositories 30-38 include a database of property data 30, a database of loan data 32 (preferably aggregated/contributed from multiple lenders, as described below), a nationwide database of aggregated public recorder data 34, a database of short sale data 36, and any other online data resources 38. Although depicted as separate databases, some of these data collections may be merged into a single database or distributed across multiple distinct databases. Further, additional databases containing other types of information may be maintained and used by the fraud applications 22. As shown in FIG. 1, each fraud application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLSs) contain data intended for realtors, and can be contacted and queried through a network such as the Internet. Such data may then be downloaded for use by embodiments of the present invention. Other examples include retrieving data from databases/websites such as Redfin, Zillow, etc. that allow users to directly post about available properties.

The database of loan data 32 preferably includes aggregated mortgage loan data collected by lenders from mortgage loan applications of borrowers. The fraud provider may obtain the loan application in various ways. For example, lenders and other users of the fraud system 20 may supply such data to the system 20 in the course of using the fraud applications 22. The users may supply such data according to an agreement under which the fraud provider and system can persistently store the data and re-use it for generating summarized analytics to provide to the same and/or other users. Such a database is maintained by CoreLogic, Inc. As another example, the fraud provider may obtain such loan data through partnership agreements. As yet another example, the fraud provider may itself be a mortgage lender, in which case the loan data may include data regarding its own loans. Loan data obtained by the fraud provider from lenders is referred to herein as “contributed loan data.”

The public recorder database 34 depicted in FIG. 1 contains aggregated data collected from public recorder offices in various counties throughout the United States. This database 34 includes property ownership information, and sales transaction histories with buyer and seller names, obtained from recorded land records (grant deeds, trust deeds, mortgages, other liens, etc.). In one embodiment, the fraud provider maintains this database 34 by purchasing or otherwise obtaining public record documents from most or all of the counties in the United States (from the respective public recorders offices), and by converting those documents (or data obtained from such documents) to a standard format. In one implementation, the database 34 covers 97% of the sales transactions from over 2,535 counties. Such a database is maintained by CoreLogic, Inc. In one embodiment, the public recorder database 34 is preferably updated on a daily or near-daily basis so that it closely reflects the current ownership statuses of properties throughout the United States.

The database of short sale data 36 preferably includes aggregated short sale data over a period of time. The fraud provider can collect data associated with pending and closed short sales periodically and store the collected data in the short sale database 36. The fraud provider may obtain the short sale data in various ways. For example, lenders and other users of the fraud system 20 may supply such data to the system 20 in the course of using the fraud applications 22. The users may supply such data according to an agreement under which the fraud provider and system can persistently store the data and re-use it for generating summarized analytics to provide to the same and/or other users. As another example, the fraud provider may obtain such short sale data through partnership agreements. As yet another example, the fraud provider may itself be a mortgage lender, in which case the short sale data may include data regarding its own short sales. As a further example, the fraud provider may access data repositories 32 and 34 to obtain such short sale data. The fraud provider may also keep a record in the short sale data of which short sale transactions have been found to be subject to short sale fraud.

Online data resources 38 include any other online resources that provide available short sale data for real estate properties. Examples of online data resources 38 containing short sale data include servers owned, operated, or affiliated with local governments, newspapers, periodicals or any other server or service containing short sale data.

As further shown in FIG. 1, the system 20 may also include one or interfaces 40 to other (externally hosted) services and databases. For example, the system may include APIs or other interfaces for retrieving data from LexisNexis, Merlin, MERS, particular real estate companies, government agencies, and other types of entities.

As further shown in FIG. 1, the fraud applications 22 include an “AVM analytics” application or application component 42 (hereinafter “application 42”). As explained below, this application or component 42 use some or all of the data sources described above to detect potential short sale fraud by performing AVM analytics on properties subject to short sales.

The analytics applications 22 also include a “relationship analysis” application or application component 44 (hereinafter “application 44”). As explained below, this application or component 44 is configured to analyze relationships between the various parties involved in a short sale to detect potential short sale fraud.

The fraud applications 22 also include a “Marketing analysis” application or application component 46 (hereinafter “application 46”). As explained below, this application or component 46 analyzes marketing information associated with short sales to detect potential short sale fraud.

The analytics applications 22 further include a “report” application or application component 48 (hereinafter “application 48”). As explained below application or component 48 can communicate with applications 42, 44, or 46, to provide a summary of the detection of potential short sale fraud in a variety of formats. In some embodiments, the report can comprise a data structure for a message alert. The message alert may include an alert number, lender name, address, city, state, zip code, loan amount, sale price, loan status (e.g., pending, or documents in preparation), last status date, expected lien position, closing date, and loan purpose (e.g., purchase, short sale). The loan purpose field can serve as an indicator of whether a particular sale is subject of a short sale. The message may be sent in any one of a variety of formats including e-mail, response to web query, client computer (or smartphone) request, facsimile, etc. The alert may also be generated in a report format, so the alert is one of a set of alerts for a portfolio of properties that were the subject of a batch query process. In some embodiments, the reports/alerts may also include information related to the fraud assessment (discussed below) and the causes and reasons for the fraud assessment. For example, for a fraud assessment risk score, the reports/alerts may include an overall fraud assessment risk score and/or the component risk scores along with the reasons/causes of the overall/component risk score assessments.

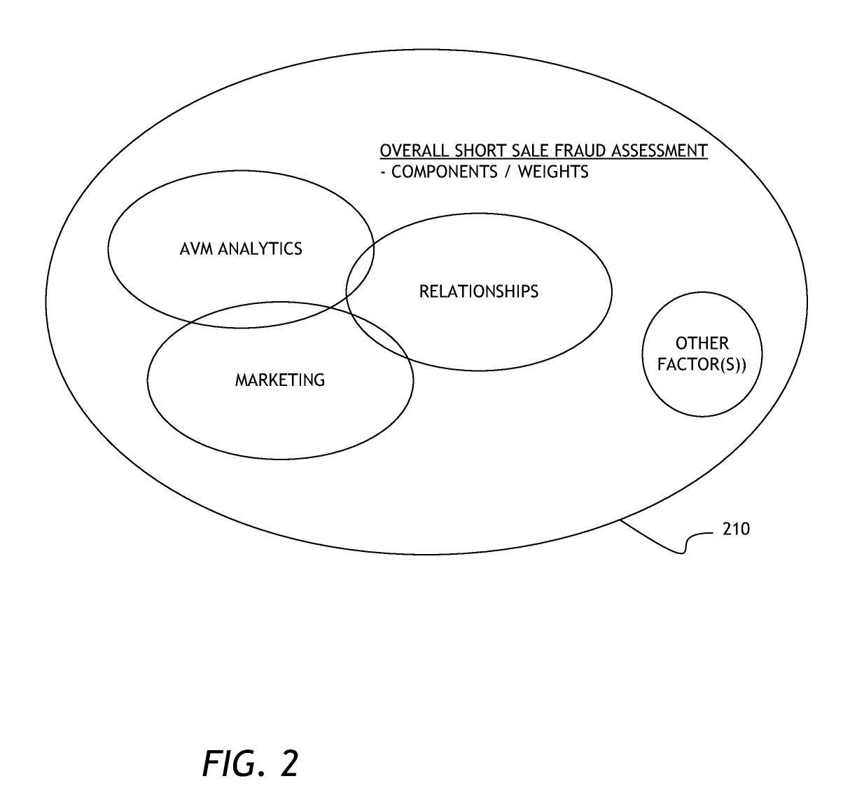

The analytics applications 22 further include a “fraud assessment” application or application component 50 (hereinafter “application 50”). As explained below application or component 50 can communicate with applications 42, 44, or 46, to determine a level of severity of a potential short sale fraud and whether an alert or notification should be generated. Application 50 can determine a short sale fraud risk, short sale fraud risk score, etc. for the particular transaction of group of transactions. The short sale fraud risk, short sale fraud risk score, etc. for a transaction of group of transactions may be determined in response to a request or can be determined on a periodic basis. The request may come from a user while the user is reviewing a transaction or group of transactions. The request can include identification information associated with a property. As illustrated in FIG. 2, an overall short sale fraud assessment 210 can based on a variety of factors, including AVM analytics, relationships characteristics, marketing information, etc. Each of these factors will be further explained below.

### AVM Analytics

Application 42 may be configured to detect potential short sale fraud by comparing a value of a property subject to a pending or closed short sale with the offer or sale price for the short sale transaction. U.S. Pat. No. 5,361,201, which is hereby incorporated by reference in its entirety, describes various systems and methods for performing automated valuations of properties. The results of the automated valuations of a property at the time the property is subject to a pending or closed short sale can be compared with the short sale offer or price. If the difference exceeds a particular threshold, then application 42 may determine that the short sale may be subject to a short sale fraud. For example, the threshold may be 10%, 20%, 30%, etc. and if the difference exceeds the threshold, then application 42 may determine that the transaction may have been or be subject to a potential short sale fraud. The threshold may be established by the fraud provider, customers, or any other entity. In some embodiments, the thresholds may be recursively adjusted after evaluating the performance and effectiveness of the AVM analytics in detecting potential short sale fraud.

Differences based on the AVM analytics, in some embodiments, may also be categorized based on their severity or sensitivity relative to potential short sale fraud. To determine the categorization, historical short sales and short sale frauds, such as those stored in data repository 36, may be analyzed by performing AVM analytics on those transactions. The attributes of the short sales and short sale frauds then may be statistically analyzed to identify the categorization for differences based on the AVM analytics. For instance, 30% of the short sales that had differences of greater than 10% were found to be short sale frauds while 60% of the short sales that had differences of greater than 20% were found to be short sale frauds. Therefore, the first grouping can be identified a very low category while the second grouping may be identified as a medium category. Similar analysis may be applied to identify other categories. A variety of other categorization methods are also contemplated by embodiments of the present invention. In some embodiments, one or more risk scores and/or indicators relating to the risk of short sale fraud may be generated. The risk scores may be generated using the categorization process discussed above. For example, a risk score of “1” can be given to the very low category and a risk score of “10” for the extreme category. Other variations for generating risk scores are possible in embodiments the present invention.

In some embodiments, specialized AVMs may be used to determine the valuations for the properties subject to a short sale. For example, AVMs specifically directed to determine automated valuations for distressed (e.g., properties in delinquency or default) properties may be used. These specialized AVMs may provide more accurate valuations than traditional AVMS, and, therefore may provide more accurate detection of potential short sale fraud. Similar AVM analytics, as discussed above, may be performed using the specialized AVMs. Similarly, an automated valuation for the property subject to a short sale transaction may be determined by the application of a valuation index, such as a Home Price Index (“HPI”) to historical prices associated with the property to determine the valuation of the property at the time of the valuation. Such specialized AVMs and valuation indexes are maintained by CoreLogic, Inc. In some embodiments, other types of valuations may be performed for comparison to the short sale transaction. For example, application 42 may access an appraisal, a Broker Price Opinion (“BPO”), etc. and perform the analytics described above based on these valuations.

### Relationship Analysis

Application 44 may be configured to detect potential short sale fraud by analyzing relationships between the various parties involved in a short sale and/or the profile of the various parties involved. Since short sale transactions typically involve multiple parties, such as a buyer, a buyer's agent, a seller, a seller's agent, relationships between the various parties or profiles of the various parties may be analyzed to detect potential short sale fraud. For example, if a buyer's agent and seller's agent have previously handled short sale transactions that were found to be subject to fraud, detecting pending short sale transactions with similar agents involved, may prevent repeated short sale fraud. As another example, if analyzing short sale data 36 suggest that certain types of buyers get involved in short sale fraud, then pending or closed short sale transactions may be analyzed to identify the profiles of the buyers to detect potential short sale fraud. For instance, in one embodiment, it may be determined that LLC buyers represent a disproportionate share of suspicious short sales. If these kinds of buyers are detected for pending or closed short sales, then potential short sale fraud by be found. As yet another example, if analyzing the short sale data 36 suggests that certain agents specialize in short sales and certain of those agents have participated in short sales fraud or agents with certain characteristics increase the likelihood of short sales fraud, then pending of closed short sale transactions may be analyzed to identify the profiles of the agents to detect potential short sale fraud. In some embodiments, the following profile characteristics may be identified that may likely be involved in short sale fraud: buyer is an LLC, buyer is a Wyoming LLC, buyer has multiple properties in their name, buyer or seller's LLC license is not in good standing, seller is not owner in property but has an equity interest in the property, registered agents of buyer or seller LLC or trusts are other LLCs or trusts, buyer or seller LLC is owned by a real estate agent, buyer or seller LLC is owned by an individual with criminal history, prior liens, or bankruptcies, buyer or seller LLC has part of property address in name, etc. A variety of other profile characteristics may be detected by embodiments of the present invention.

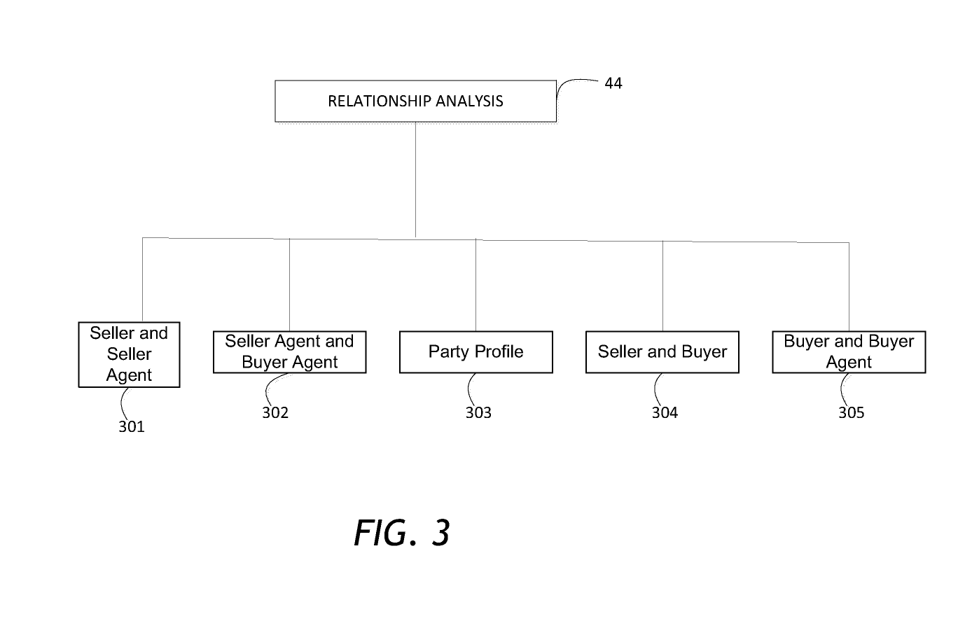

FIG. 3 illustrates a variety of possible factors that may be analyzed by the fraud detection process. As illustrated, the factors may comprise relationship between seller and seller agent 301, relationship between seller agent and buyer agent 302, party profile 303, relationship between buyer and seller 304, and relationship between buyer and buyer agent 305.

To determine the profiles or relationships that may be related to potential short sale fraud, loan database 32, aggregated public recorder data 34, short sale data 36, and online data resources 38 may be analyzed. The data may be analyzed to determine characteristics of relationships/profiles that exist in short sales versus characteristics of relationships/profiles that exist in conventional sales transactions. Similarly, the data may be analyzed to determine characteristics of relationships/profiles that exist in short sales fraud. For example, in some embodiments, the fraud provider may determine by analyzing the data that if the various parties described above, include relationships but not limited to relatives, employment together, live in close vicinity to each other, etc. then the transactions may be subject to potential short sale fraud. Additional examples of relationship characteristics that may be found include previously employed/worked together have previously done business together, have known each other for a threshold amount of time, are close friends, live at same address, are social networking contacts, etc. The fraud provider may analyze online data sources, such Internet websites or pages to determine characteristics of relationships/profiles that exist in short sale fraud. For example, application 44 may analyze the social networking profiles and contacts of parties previously involved in short sale fraud and determine if they are contacts with each other, what kind of profiles the parties had, etc. and identify if any pending or closed short sales of interest include similar relationships/profiles.

In terms of profiles, the fraud provider may determine by analyzing the data the identity of the parties, the amount of short sales individual parties have been associated with, the financial characteristics associated with the various parties, amount of financing associated with the various parties, or any other profile characteristic that may affect risk that the transactions may be subject to potential short sale fraud. A variety of different kind of relations/profiles may be identified in embodiments of the present invention by analyzing the data described above.

In various embodiments, the characteristics of relationships/profiles that relate to potential sales fraud may depend on the nature of relationship/profile. For example, a buyer and seller having a family relationship may suggest a higher risk of potential sale fraud then a family relationship between a seller and a seller's agent. As another example, an LLC as a buyer may suggest a higher risk of potential sale fraud versus an LLC as a seller. The characteristics of relationships/profiles and the nature of the relationship/profile that may identify potential short sales fraud may be identified by analyzing the data discussed above and stored in a mapping table. The mapping table then can be evaluated in reference to pending or closed short sales transactions to identify any transactions that may be subject to potential short sale fraud.

Characteristics of the relationships/profiles, in some embodiments, may also be categorized based on their severity or sensitivity relative to potential short sale fraud. To determine the categorization, historical short sales and short sale frauds, such as those stored in data repository 36, may be analyzed by performing relationship/profile analysis on those transactions. The attributes of the short sales and short sale frauds then may be statistically analyzed to identify the categorization for the characteristics of the relationships/profiles. For instance, 22% of the short sales that had LLC as the buyer found to be short sale frauds while 2% of the short sales that had parties with an existing relationship found to be short sale frauds. Therefore, the first grouping can be identified a very high category while the second grouping may be identified as a very low category. Similar analysis may be applied to identify other categories. A variety of other categorization methods are also contemplated by embodiments of the present invention. In some embodiments, one or more risk scores and/or indicators relating to the risk of short sale fraud may be generated. The risk scores may be generated using the categorization process discussed above. For example, a risk score of “1” can be given to the very low category and a risk score of “10” for the extreme category. Other variations for generating risk scores are possible in embodiments the present invention. For example, a risk score may be provided for each risk factor component and combined (e.g., average, weighted average, summed, etc.) A risk score may be determined for the buyer profile, buyer agent profile, seller, seller agent profile etc., and combined with a risk score for relationship characteristics between the buyer and seller, buy and buyer agent, buyer and seller agent, seller and seller agent, etc. A variety of variations are possible in embodiments of the present invention.

### Marketing Analysis

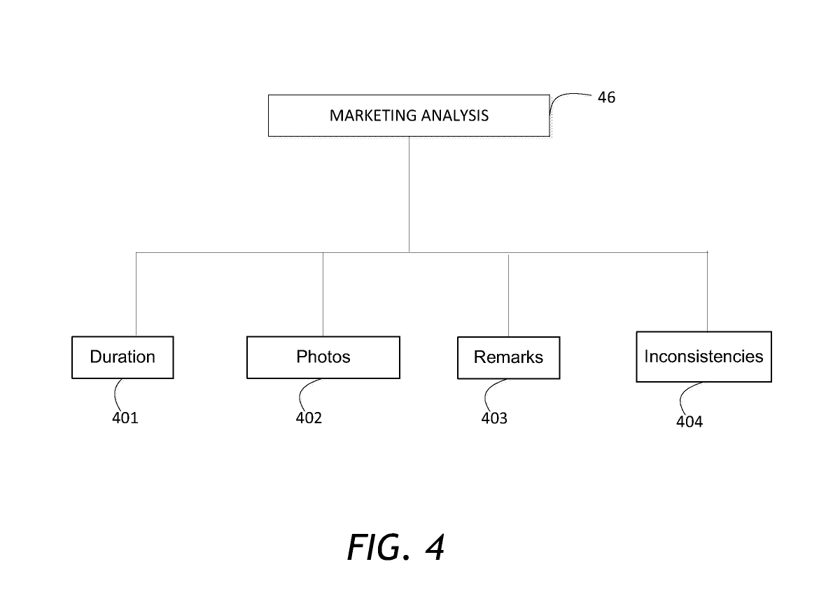

Application 46 may be configured to detect potential short sale fraud by analyzing marketing information associated with short sales transactions. FIG. 4 illustrates various marketing information that may be analyzed by the fraud provider to detect potential shorts sale fraud. As illustrated, duration 401, number or quality of photographs 402, remarks 403, inconsistencies 404 associated with any short sale listings may be analyzed to detect any potential short sale fraud. Duration 401 in embodiments of the present invention can relate to the duration of advertising associated with the short sale transactions. For example, duration of an active listing for the properties associated with the short sale transactions on a multiple listing service (“MLS”), online website, or any other advertising medium.

Photographs 402 may relate to the number, type, quality, etc. of photographs associated with the advertising of the properties associated with the short sales transactions. It may be determined that transactions involving short sales fraud include fewer number of photographs, poorer quality photographs, photographs of narrow aspects of the property, etc. Remarks 403 may relate to the length, content, or quality of the remarks associated with advertising associated with the short sales transactions. For example, fraud provider may analyze the data described above to determine that short sale frauds may typically include certain specific terms (e.g., “improved,” fixer upper,” “back up offers,” etc.), less than 100 words, a certain percentage of typographical/grammatical errors, etc.

Inconsistencies 404 may relate to any inconsistencies between the advertising of the properties associated with the short sales transactions and any public records. For instance, it may be determined that transactions involving short sales fraud include inconsistent owner names in comparison to public records, incorrect number of bedrooms/bathrooms, incorrect square footage, incorrect address, etc. Marketing information from online data sources 38 associated with short sales versus traditional sales may be analyzed and compared to public records (e.g., aggregated public recorder data 34) to detect any statistical patterns that may increase the risk of short sale fraud. For example, the fraud provider may determine that short sales fraud transactions may include at a higher percentage marketing information that includes a lower number of photographs that have poor quality, little or negative remarks in the text, short duration of active listings, and/or inconsistencies with public records, compared to traditional sales transactions. The characteristics of the marketing information and the nature of the marketing information that may detect potential short sales fraud may be identified by analyzing the data discussed above and stored in a mapping table. The mapping table then can be evaluated in reference to pending or closed short sales transactions to identify any transactions that may be subject to short sale fraud.

Characteristics of the marketing information, in some embodiments, may also be categorized based on their severity or sensitivity relative to potential short sale fraud. To determine the categorization, historical short sales and short sale frauds, such as those stored in data repository 36, may be analyzed by performing marketing information analysis on those transactions. The attributes of the short sales and short sale frauds then may be statistically analyzed to identify the categorization for the characteristics of the marketing information. For instance, 11% of the short sales that had less than 5 days of active listing on an MLS found to be short sale frauds while 36% of the short sales that had less than 1 day of active listing on an MLS found to be short sale frauds. Therefore, the first grouping can be identified a medium category while the second grouping may be identified as a very high category. Similar analysis may be applied to identify other categories. A variety of other categorization methods are also contemplated by embodiments of the present invention. In some embodiments, one or more risk scores and/or indicators relating to the risk of short sale fraud may be generated. The risk scores may be generated using the categorization process discussed above. For example, a risk score of “1” can be given to the very low category and a risk score of “10” for the extreme category. Other variations for generating risk scores are possible in embodiments the present invention. For example, a risk score may be provided for each risk factor component and combined (e.g., average, weighted average, summed, etc.) A risk score may be determined for the duration, photographs, remarks, inconsistencies, etc., and combined. A variety of variations are possible in embodiments of the present invention.

### Example Real Estate AVM Analytics Process

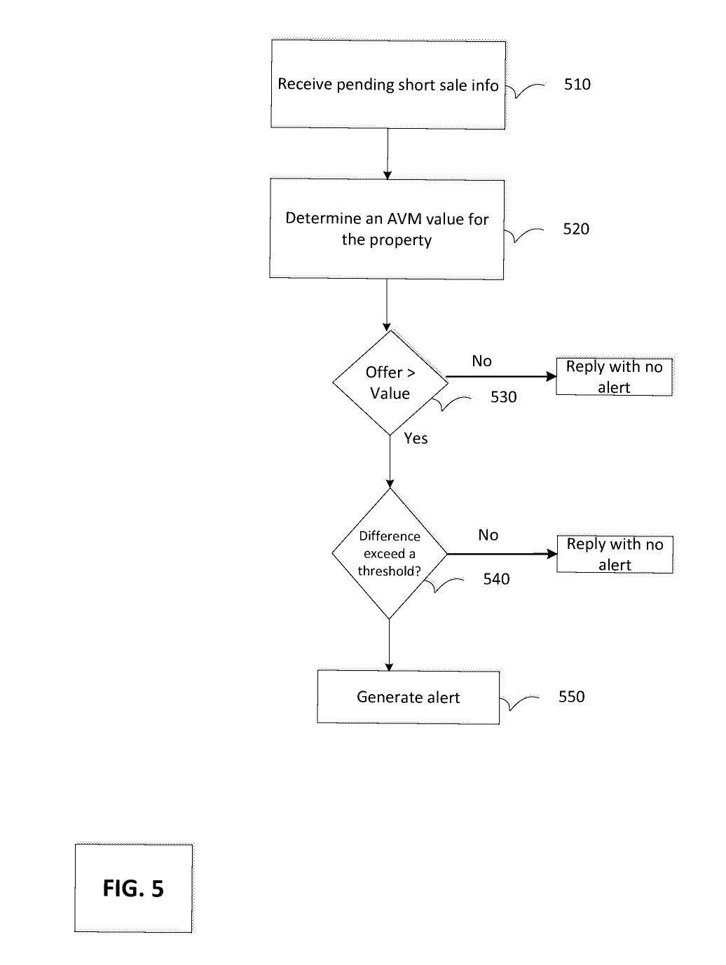

FIG. 5 illustrates one embodiment of an automated process that may be used by the analytics applications 22 to detect potential short sale fraud by performing AVM analytics on properties subject to short sales. As mentioned above, this process may be useful (as one example) for enabling a lender to assess fraud and financial risks associated with real estate properties. FIG. 5 illustrates a pre-closing short sale method performed according to one embodiment.

As depicted by block 510 of FIG. 5, the application 44 initially receives pending short sale information. That information may include property information such as a complete property address as well as the proposed short sale price. One or a set of properties may be included in the request. If a set of properties is included, the properties are evaluated sequentially, although parallel processing may also be used if sufficient instances of the software processes are available. Also the input information can include loan information such as the loan number, short sale status (pending/closed), status date, and/or the unpaid balance. Optionally other information may be included as well such as the borrowers' names, buying/selling agent, title/escrow companies, settlement agents, appraiser, and appraisal amount. Application 44 may communicate with computing device 26 to receive the pending short sale information. The application 44 may then, in some embodiments, process the received pending short sale information to uniquely identify the subject property of interest by, for example, communicating with data repositories 30-38 or any other data repository to map the received pending short sale information to the subject property.

As shown in block 520 of FIG. 5, an AVM value for the subject property may then be determined. As explained above, the application 44 may access an AVM to determine an automated value for the subject property. In some embodiments, specialized AVMs may be used. In one embodiment, automated values may be determined by other means, such as appraisals, valuation indexes, BPOs, etc.

As depicted by blocks 530 of FIG. 5, the automated value is compared to the received pending short sale information. The proposed short sale price is compared to the automated value to detect any potential short sale fraud. If it is determined that the proposed short sales price is greater than then determined automated value, then either a confirmation reply is sent with no alert, or no reply is sent at all. However, if the proposed short sales price is less than the automated value, then a determination is made whether the difference exceeds a certain threshold (block 540). As discussed above, the threshold may be established by the fraud provider, lender, customer, or any other entity and can be adjusted dynamically based on performance.

If the comparison does not exceed the particular threshold, then either a confirmation reply is sent with no alert, or no reply is sent at all. However, if the comparison does exceed the particular threshold, then an alert is generated (block 550). As discussed above, the alert may include information related to the AVM analytics and the reasons/causes of the alerts, such as the automated value, the threshold, etc. The contribution of the determined values on potential short sale fraud may also be identified as discussed above.

### Example Real Estate Relationships Analysis Process

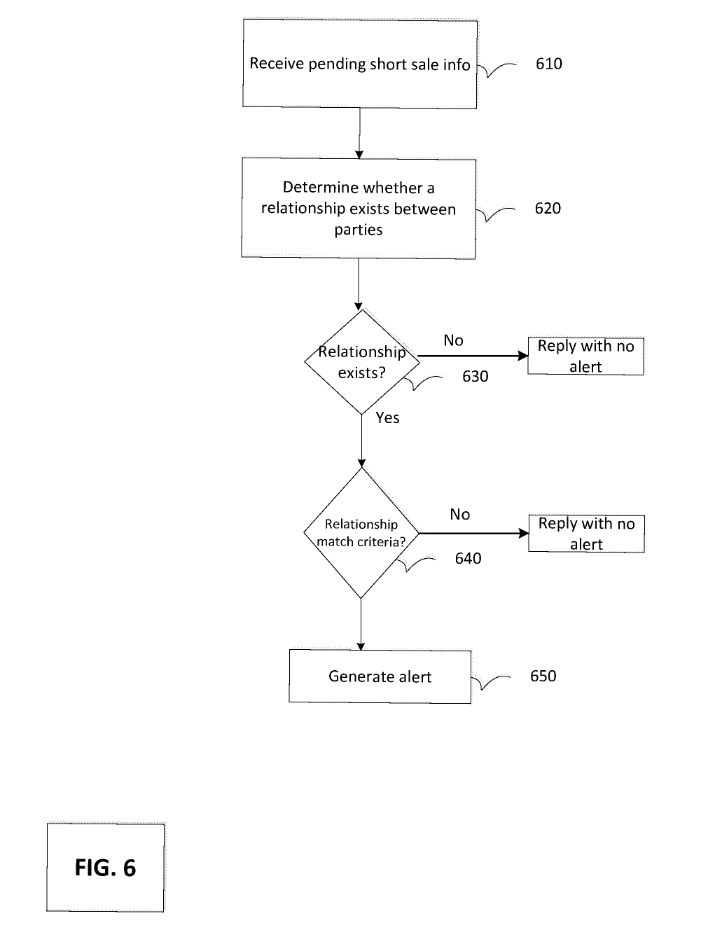

FIG. 6 illustrates one embodiment of an automated process that may be used by the analytics applications 22 to detect potential short sale fraud by performing relationships analysis on properties subject to short sales. As mentioned above, this process may be useful (as one example) for enabling a lender to assess fraud and financial risks associated with real estate properties. FIG. 6 illustrates a pre-closing short sale method performed according to one embodiment.

As depicted by block 610 of FIG. 6, the application 44 initially receives pending short sale information. That information may include property information such as a complete property address as well as the proposed short sale price. One or a set of properties may be included in the request. If a set of properties is included, the properties are evaluated sequentially, although parallel processing may also be used if sufficient instances of the software processes are available. Also the input information can include loan information such as the loan number, short sale status (pending/closed), status date, and/or the unpaid balance. Optionally other information may be included as well such as the borrowers' names, buying/selling agent, title/escrow companies, settlement agents, appraiser, and appraisal amount. Application 44 may communicate with computing device 26 to receive the pending short sale information. The application 44 may then, in some embodiments, process the received pending short sale information to uniquely identify the subject property of interest by, for example, communicating with data repositories 30-38 or any other data repository to map the received pending short sale information to the subject property.

As shown in block 620 of FIG. 6, the relationships between the parties involved in the short sale transaction are determined. As explained above, the application 44 may access data repositories 30-38 to identify and relationships between the buyer and buyer agent, seller and seller agent, buyer and seller, and seller agent and buyer agent. In some embodiments, profiles of the parties may also be analyzed as discussed above.

As depicted by blocks 630 of FIG. 6, the identified relationships are analyzed. If it is determined that no relationships exist between the parties, then either a confirmation reply is sent with no alert, or no reply is sent at all. However, if any relationships are found, then a determination is made whether the relationships match particular criteria (block 640). As discussed above, certain relationships may be determined to indicative of potential short sale fraud and a mapping table may be used to analyze the relationships. These relationships may be identified by analyzing historical data as discussed above. The relationship criteria may be established by the fraud provider, lender, customer, or any other entity and can be adjusted dynamically based on performance.

If the relationship does not match the relationship criteria, then either a confirmation reply is sent with no alert, or no reply is sent at all. However, if the relationship does match the relationship criteria, then an alert is generated (block 650). As discussed above, the alert may include information related to the relationship and the reasons/causes of the alerts, such as the identified relationship/profile, the relationship/profile criteria, etc. The contribution of the determined values on potential short sale fraud may also be identified as discussed above.

### Example Real Estate Relationships Analysis Process

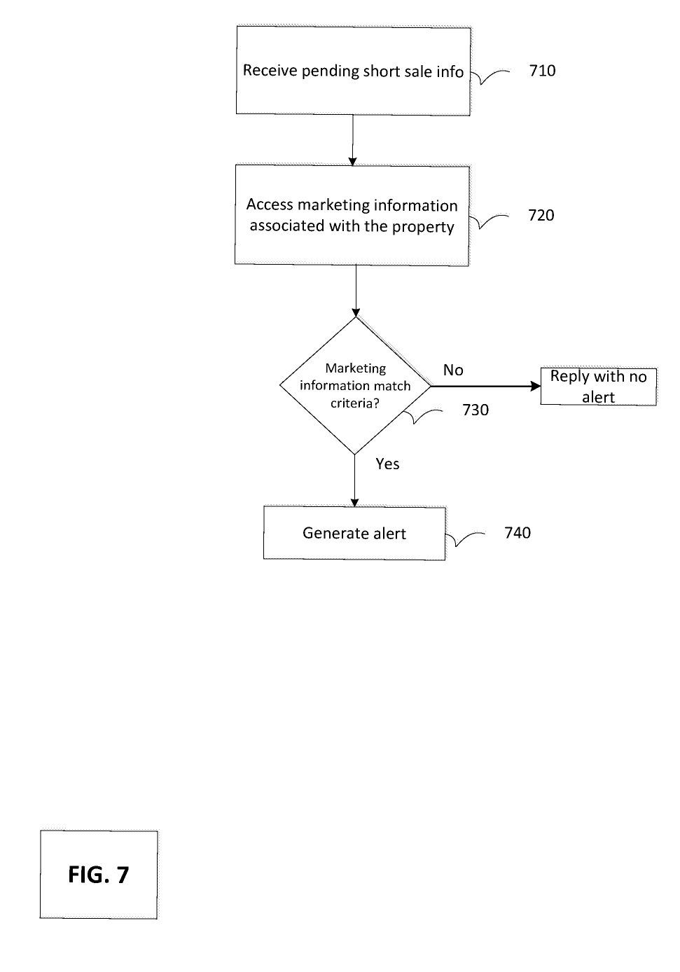

FIG. 7 illustrates one embodiment of an automated process that may be used by the analytics applications 22 to detect potential short sale fraud by performing marketing analysis on properties subject to short sales. As mentioned above, this process may be useful (as one example) for enabling a lender to assess fraud and financial risks associated with real estate properties. FIG. 7 illustrates a pre-closing short sale method performed according to one embodiment.

As depicted by block 710 of FIG. 7, the application 46 initially receives pending short sale information. That information may include property information such as a complete property address as well as the proposed short sale price. One or a set of properties may be included in the request. If a set of properties is included, the properties are evaluated sequentially, although parallel processing may also be used if sufficient instances of the software processes are available. Also the input information can include loan information such as the loan number, short sale status (pending/closed), status date, and/or the unpaid balance. Optionally other information may be included as well such as the borrowers' names, buying/selling agent, title/escrow companies, settlement agents, appraiser, and appraisal amount. Application 46 may communicate with computing device 26 to receive the pending short sale information. The application 46 may then, in some embodiments, process the received pending short sale information to uniquely identify the subject property of interest by, for example, communicating with data repositories 30-38 or any other data repository to map the received pending short sale information to the subject property.

As shown in block 720 of FIG. 7, the marketing information associated with the short sale transaction is accessed. As explained above, the application 46 may access data repositories 30-38 to identify any relevant marketing information, including advertisements, photographs, remarks, etc.

As depicted by blocks 730 of FIG. 7, the identified marketing information is analyzed to make a determination of whether the marketing information matches particular criteria (block 730). As discussed above, certain types of marketing information may be determined to indicative of potential short sale fraud and a mapping table may be used to analyze the marketing information. These types of marketing information may be identified by analyzing historical data as discussed above. The marketing criteria may be established by the fraud provider, lender, customer, or any other entity and can be adjusted dynamically based on performance.

If the marketing information does not match the marketing criteria, then either a confirmation reply is sent with no alert, or no reply is sent at all. However, if the marketing information does match the marketing criteria, then an alert is generated (block 740). As discussed above, the alert may include information related to the marketing information and the reasons/causes of the alerts, such as the identified marketing information, any inconsistencies, marketing criteria, etc. The contribution of the determined values on potential short sale fraud may also be identified as discussed above.

### Example Real Estate Short Sale Fraud Risk Determination Process

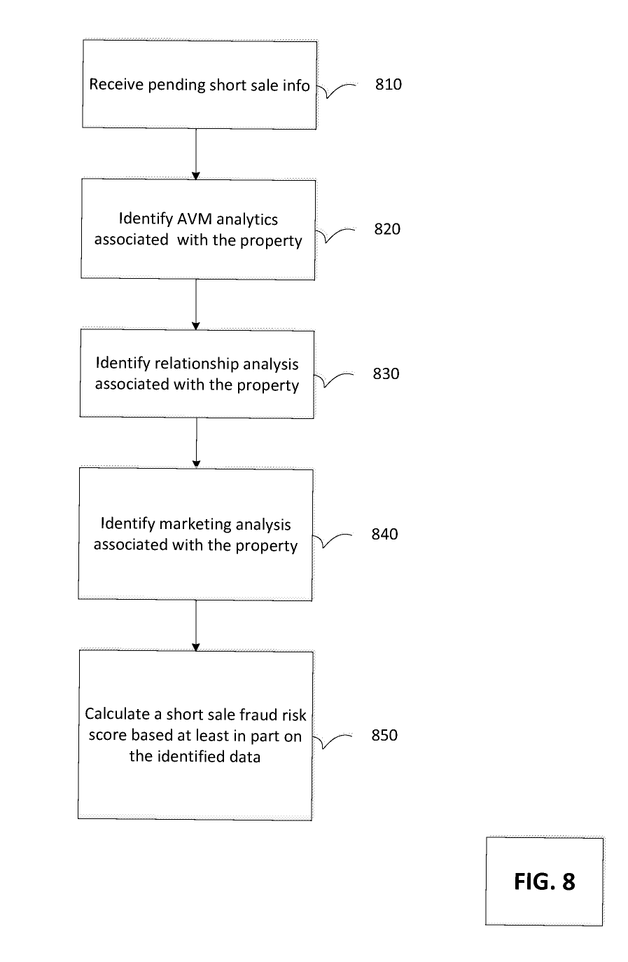

FIG. 8 illustrates one embodiment of an automated process that may be used by the fraud assessment module 50 to identify short sale fraud risks for real estate properties. In some embodiments, short sale fraud risks may be provided as a quantitative identifier, such as a score, rank, range, etc., or a qualitative identifier, such as high, low, “A,” “C,” etc.

As depicted by block 810 of FIG. 8, the application 50 initially receives pending short sale information. That information may include property information such as a complete property address as well as the proposed short sale price. One or a set of properties may be included in the request. If a set of properties is included, the properties are evaluated sequentially, although parallel processing may also be used if sufficient instances of the software processes are available. Also the input information can include loan information such as the loan number, short sale status (pending/closed), status date, and/or the unpaid balance. Optionally other information may be included as well such as the borrowers' names, buying/selling agent, title/escrow companies, settlement agents, appraiser, and appraisal amount. Application 50 may communicate with computing device 26 to receive the pending short sale information. The application 50 may then, in some embodiments, process the received pending short sale information to uniquely identify the subject property of interest by, for example, communicating with data repositories 30-38 or any other data repository to map the received pending short sale information to the subject property.

As depicted by block 820 of FIG. 8, the application 42 identifies AVM analytics characteristics associated with a subject property. As discussed above, application 42 may communicate with data repositories 30-38 to determine an automated value for the subject property and compare the value with short sale information associated with the subject property. The contribution of the determined values on short sale fraud potential may also be identified as discussed above.

As shown in block 830 of FIG. 8, the application 44 then optionally identifies relationship analysis characteristics associated with the subject property. Data repositories 30-38 may be used to determine any relations and/or profiles of the parties related to short sale transactions related to the subject property as enumerated in FIG. 2. The contribution of the determined values on short sale fraud potential may also be identified as discussed above

As depicted by blocks 840 of FIG. 8, the application 46 then optionally identifies marketing analysis information associated with the subject property. Data repositories 30-38 may be used to determine the marketing information enumerated in FIG. 4 and perform the marketing analysis discussed above. The contribution of the determined values on short sale fraud potential may also be identified as discussed above

Subsequently, as depicted by blocks 850 of FIG. 8, a short sale fraud score may be computed based at least in part on the identified data, identified categories, and/or identified risk scores. By way of example, multiple factors discussed above that may be considered in computing a short sale fraud risk score include AVM analytics assessments, number of photographs, quality/type of advertising remarks, duration of advertising, inconsistencies with public records, relationships or profiles of parties involved, etc. The generated scores from the individual factors may also be processed, e.g., combined and/or mathematically manipulated into input features that will serve as input to the short sale fraud model in use. An example input feature may be the maximum of two or more risk scores, e.g., max(risk score 1, risk score 2, . . . , risk score n). Another example input feature may be the average of several risk scores. In other embodiments, the risks scores may be combined by a weighted average. Initial weights for each factor discussed above may be assigned at random or may represent estimations. Changing the weight of the various factors may then result in better or worse models. Such modeling may be done by a number of well-known methods such as through the use of neural networks, logistic regression and the like. The approach may also be hands-on with statisticians or others aiding the modeling process or automated, such as with back propagation in a neural network to improve modeling.

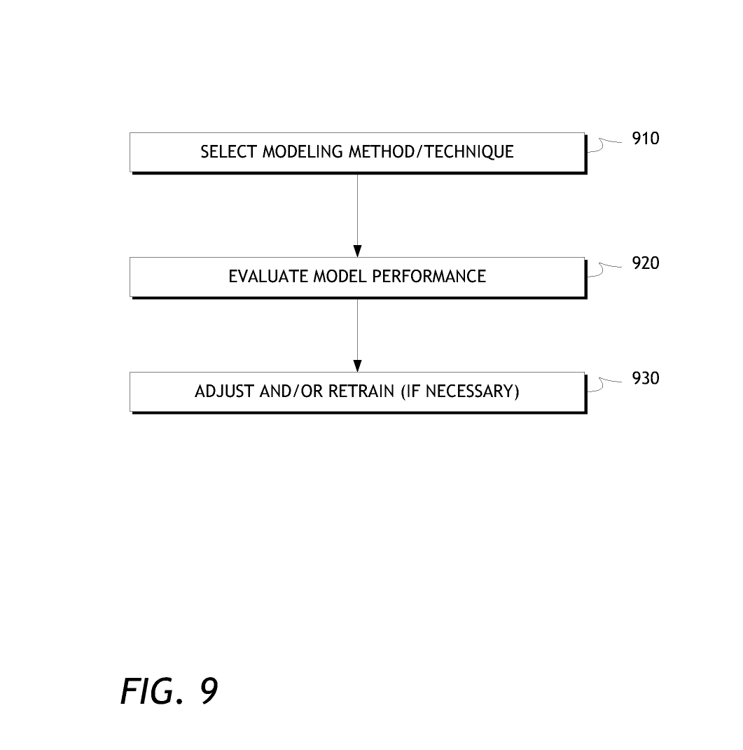

As depicted of FIG. 9, generating a short sale fraud risk model includes selecting modeling method(s)/technique(s) (block 910). Example modeling techniques may include but are not limited to linear regression, logistic regression, neural networks, support vector machines, decision trees, and their derivatives. Suitable modeling methods may include machine learning/data mining techniques including linear regression, logistic regression, neural networks, support vector machine, decision tree, etc. In practice, one technique can be used in the research effort to provide insights for another modeling technique. Thus a combination of techniques can be used in the analysis and in the product implementation.

As discussed above, suitable modeling methods include linear regression and/or logistic regression. Linear regression is a widely used statistical method that can be used to predict a target variable using a linear combination of multiple input variables. Logistic regression is a generalized linear model applied to classification problems. It predicts log odds of a target event occurring using a linear combination of multiple input variables. These linear methods have the advantage of robustness and low computational complexity. These methods are also widely used to classify non-linear problems by encoding the nonlinearity into the input features. Although the mapping from the feature space to the output space is linear, the overall mapping from input variables through features to output is nonlinear and thus such techniques are able to classify the complex nonlinear boundaries. Desirably, the linear mapping between the feature space and the output space may make the final score easy to interpret for the end users.

Another suitable modeling method is neural networks. Logistic regression generally needs careful coding of feature values especially when complex nonlinear problems are involved. Such encoding needs good domain knowledge and in many cases involves trial-and-error efforts that could be time-consuming. A neural network has such nonlinearity classification/regression embedded in the network itself and can theoretically achieve universal approximation, meaning that it can classify any degree of complex problems if there is no limit on the size of the network. However, neural networks are more vulnerable to noise and it may be more difficult for the end users to interpret the results. In one embodiment, one suitable neural network structure is the feed-forward, back-prop, 1 hidden layer version. Neural networks may provide more robust models to be used in production environments when based on a larger data set than would be need to provide robust models from logistic regression. Also, the number of hidden nodes in the single hidden layer is important: too many nodes and the network will memorize the details of the specific training set and not be able to generalize to new data; too few nodes and the network will not be able to learn the training patterns very well and may not be able to perform adequately. Neural networks are often considered to be “black boxes” because of their intrinsic non-linearity. Hence, in embodiments where neural networks are used, when higher short sale fraud risks are returned accompanying reasons are also provided. One such option is to provide short sale fraud indicators in conjunction with scores generated by neural network based models, so that the end user can more fully understand the decisions behind the high short sale fraud risks.

Embodiments may also include models that are based on support vector machines (SVMs). A SVM is a maximum margin classifier that involves solving a quadratic programming problem in the dual space. Since the margin is maximized, it will usually lead to low generalization error. One of the desirable features of SVMs is that such a model can cure the “curse of dimensionality” by implicit mapping of the input vectors into high-dimensional vectors through the use of kernel functions in the input space. A SVM can be a linear classifier to solve the nonlinear problem. Since all the nonlinear boundaries in the input space can be linear boundaries in the high-dimensional functional space, a linear classification in the functional space provides the nonlinear classification in the input space. It is to be recognized that such models may require very large volume of independent data when the input dimension is high.

Embodiments may also include models that are based on decision trees. Decision trees are generated using a machine learning algorithm that uses a tree-like graph to predict an outcome. Learning is accomplished by partitioning the source set into subsets using an attribute value in a recursive manner. This recursive partitioning is finished when pre-selected stopping criteria are met. A decision tree is initially designed to solve classification problems using categorical variables. It can also be extended to solve regression problem as well using regression trees. The Classification and Regression Tree (CART) methodology is one suitable approach to decision tree modeling. Depending on the tree structure, the compromise between granular classification, (which may have extremely good detection performance) and generalization, presents a challenge for the decision tree. Like logistic regression, results from decisions trees are easy to interpret for the end users.

Once the modeling method is determined, the short sale fraud risk model is trained based on the historical data adaptively. The parameters of the model “learn” or automatically adjust to the behavioral patterns in the historical data and then generalize these patterns for detection purposes. When new short sale data is detected, the model will evaluate its short sale fraud risk based on what it has learned in its training history. The modeling techniques for generating the short sale fraud risk may be adjusted in the training process recursively.

The listing of modeling techniques provided herein are not exhaustive. Those skilled in art will appreciate that other predictive modeling techniques may be used in various embodiments. Example predictive modeling techniques may include Genetic Algorithms, Hidden Markov Models, Self Organizing Maps, Dynamic Bayesian Networks, Fuzzy Logic, and Time Series Analysis. In addition, in one embodiment, a combination of the aforementioned modeling techniques and other suitable modeling techniques may be used in the short sale fraud risk model.

As depicted in block 920 of FIG. 9, the performance of the short sale fraud risk model may be evaluated in its predictive power and generalization prior to release to production. For example, in one embodiment the performance of a short sale fraud risk model is evaluated on both the training dataset and the testing dataset, where the testing dataset is not used during the model development. The difference between the performance in the training data and the testing data demonstrates how robust the model is and how much the model is able to generalize to other datasets. The closer the two performances are, the more robust the model is.

Finally, at a block 930, the short sale fraud risk model may be adjusted and/or retrained as needed. For example, the short sale fraud risk model may be adjusted to use a different modeling technique, based on the evaluation of the model performance. The adjusted short sale fraud risk model may then be re-trained. In another example, the short sale fraud risk model may be re-trained using updated and/or expanded data (e.g., short sale data) as they become available.

The outputs of the short sale fraud model may be collected by application 50 to identify any short sale fraud trends. The application 50 may collect short sale fraud outputs from the generated short sale fraud model at periodic intervals to identify short sale fraud trends. The identified short sale fraud outputs and/or trends may be stored or provided to interested parties, such as the computing device 26.

### Example Real Estate Short Sale Fraud Risk Determination Process

It should be appreciated that embodiments of the present invention can be used for both pending sales and also for post closing activity. For example, if a fraudulent short sale “flip” is not detected before the short sale closes, identifying a suspicious short sale after closing still allows a servicer to identity any industry insiders or middlemen who are perpetrating the fraud. Servicers can choose to prohibit future business relationship or short sale offers related to persons identified as having perpetrated fraud in the past. As another example, identifying a suspicious short sale after closing still allows mortgage insurers to decline or reduce payments for claims.

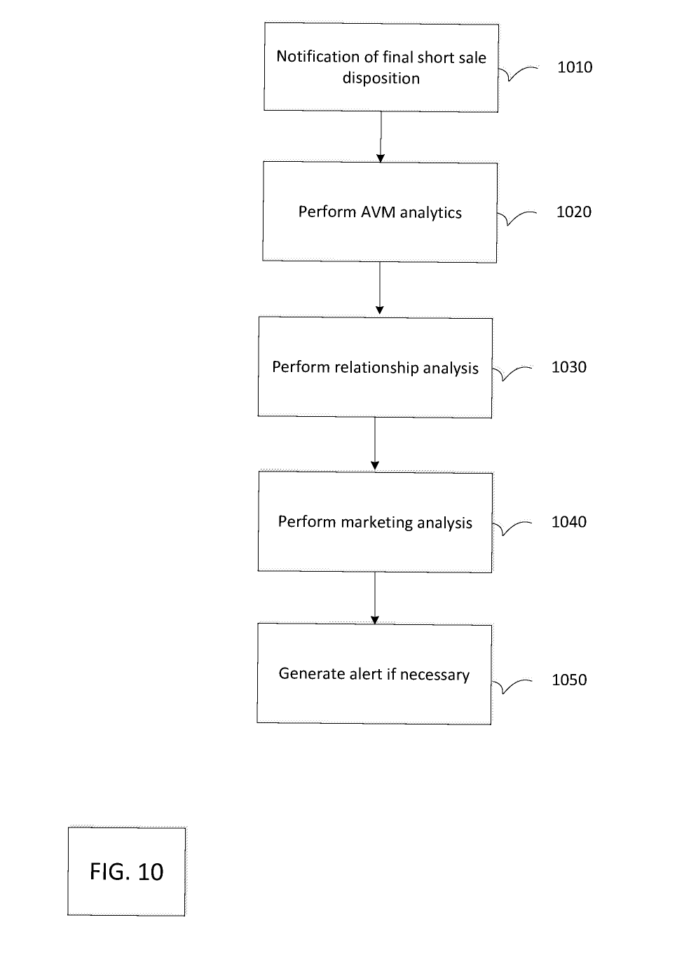

FIG. 10 is a flow chart showing a process flow for detecting post-closing short sale potentially fraudulent activity. The process begins in block 1010 where notification of a final short sale disposition is received. Subsequently, as depicted by block 1020, the application 42 identifies AVM analytics characteristics associated with a subject property. As discussed above, application 42 may communicate with data repositories 30-38 to determine an automated value for the subject property and compare the value with short sale information associated with the subject property. The contribution of the determined values on short sale fraud potential may also be identified as discussed above.

As shown in block 1030 of FIG. 10, the application 44 then optionally identifies relationship analysis characteristics associated with the subject property. Data repositories 30-38 may be used to determine any relationships and/or profiles of the parties related to short sale transactions related to the subject property as enumerated in FIG. 2. The contribution of the determined values on short sale fraud potential may also be identified as discussed above.

As depicted by blocks 1040 of FIG. 10, the application 46 then optionally identifies marketing analysis information associated with the subject property. Data repositories 30-38 may be used to determine the marketing information enumerated in FIG. 4 and perform the marketing analysis discussed above. The contribution of the determined values on short sale fraud potential may also be identified as discussed above.

Finally, as depicted by blocks 1050 of FIG. 10, the application 50 then generates an alert if necessary. As discussed above, if the assessment of short sale fraud meets certain criteria, then an alert may be generated.

### CONCLUSION

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as AVM analytics module 42, relationship analysis module 44, marketing analysis 46, report module 48, and fraud assessment module 50, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-38, relational databases and flat file systems that use magnetic disk storage and/or solid state RAM. Some or all of the components shown in FIG. 1, such as those that are part of the Fraud System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A computer-implemented process for detecting potential short sale fraud, the process comprising:
receiving, by a data processor of a computer system through a network communication channel, property identification information for a property, a short sale notification regarding a short sale of the property, and a short sale price;
requesting, by the data processor of the computer system, calculation of a short sale fraud risk score associated with the short sale of the property, wherein the short sale fraud risk score is calculated by applying a short sale fraud risk model to the property, the short sale fraud risk model generated based at least in part on a determined automated value associated with the real estate property, determined relationship analysis associated with the short sale of the property, and determined marketing analysis associated with the short sale of the real estate property;
receiving, by the data processor of the computer system, the calculated short sale fraud risk score associated with the property; and
storing, by the data processor of the commuter system, the calculated short sale fraud risk score in a data repository.

2. The process of claim 1, wherein the short sale fraud risk model comprises a regression model.

3. The process of claim 1, wherein the relationship analysis comprises determining whether a relationship exists between the buyer, seller, buyer agent, and seller agent associated with the short sale of the property.

4. The process of claim 1, wherein the marketing analysis comprises determining any photographs associated with marketing of the property.

5. The process of claim 1, wherein the short sale fraud risk model is further generated based at least in part on determined profile characteristics associated with parties involved with the short sale of the property.

6. The process of claim 1, wherein the profile characteristics comprise whether the parties have previously been involved with short sales.

7. The process of claim 1, wherein the profile characteristics comprise whether the parties include an LLC.

8. A system comprising:
physical data storage configured to store property information; and
a computer system in communication with the physical data storage, the computer system comprising computer hardware, the computer system programmed to:
receive property identification information for a property, a short sale notification regarding a short sale of the property, and a short sale price;
determine an automated value for the property by accessing the property information stored in the physical data storage;
determine a difference between the determined automated value and the short sale price;
determine marketing information associated with the short sale of the property;
perform marketing analysis on the marketing information to determine any marketing analysis characteristics associated with the short sale of the property;
generate an alert when the difference between the determined automated value and the short sale price exceeds a predetermined threshold and the marketing analysis characteristics match predetermined marketing criteria that is indicative of potential short sale fraud.

9. The system of claim 8, wherein the computer system is further programmed to:
perform relationship analysis based on the short sale of the property; and
generate the alert when the relationship analysis matches predetermined relationship criteria that is indicative of potential short sale fraud.

10. The system of claim 8, wherein the relationship analysis comprises determining whether a relationship exists between the buyer, seller, buyer agent, and seller agent associated with the short sale of the property.

11. The system of claim 10, wherein the predetermined relationship criteria comprises at least one of a relative, friend, or business acquaintance.

12. The system of claim 8, wherein the marketing analysis comprises determining any photographs associated with marketing of the property.

13. The system of claim 12, wherein the predetermined marketing criteria comprises a predetermined number of photographs.

14. The system of claim 8, wherein the marketing analysis comprises determining any remarks associated with marketing of the property.

15. The system of claim 14, wherein the predetermined marketing criteria comprises a predetermined list of terms.

16. The system of claim 8, wherein the marketing analysis comprises determining duration of time any advertising associated with marketing of the property is active.

17. The system of claim 16, wherein the predetermined marketing criteria comprises a predetermined amount of time.

18. The system of claim 8, wherein the automated value is determined by applying an AVM to the property.

19. The system of claim 19, wherein the AVM is an AVM specifically directed to determine automated values for distressed properties.

20. The system of claim 8, wherein the short sale notification is received post-closing of the short sale.

21. The system of claim 10, wherein the predetermined relationship criteria comprises a social networking contact.

22. The system of claim 14, wherein the marketing analysis comprises determining length of any remarks associated with marketing of the property.

23. The system of claim 8, wherein the computer system is further programmed to:
provide the generated alert to a mortgage insurer, wherein the mortgage insurer may review insurance claims based at least in part on the generated alert.
